(19) United States
(12) Patent Application Publication
(10) Pub. No.: US 2026/0214556 A1
(43) Pub. Date: Jul. 23, 2026

(54) DISCOVERY-BASED PAGING

(71) Applicant: QUALCOMM Incorporated, San Diego, CA (US)

(72) Inventors: Shankar KRISHNAN, Poway, CA (US); Karl Georg HAMPEL, Jersey City, NJ (US); Gavin Bernard HORN, La Jolla, CA (US); Naeem AKL, Bridgewater, NJ (US); Prasada Veera Reddy KADIRI, San Diego, CA (US); Ozcan OZTURK, San Diego, CA (US)

(21) Appl. No.: 19/030,034

(22) Filed: Jan. 17, 2025

(51) Int. Cl. H04W 48/16; H04L 5/00; H04W 60/04; H04W 68/02

(52) U.S. Cl. CPC H04W 48/16; H04L 5/0053; H04W 60/04; H04W 68/02

(57) ABSTRACT

Various aspects of the present disclosure generally relate to wireless communication. Some aspects more specifically relate to a discovery procedure that enables a network function (NF) to identify information that is relevant to paging and thereby directly page a user equipment (UE). In some aspects, a network repository function (NRF) may receive registration information from a distributed unit (DU), such as a DU identifier, area information, and/or cell information. The NF may send, to the NRF, a discovery request that specifies target attributes for the paging, such as a cell type or an area, among other examples. The NF may receive, from the NRF, a discovery response that indicates cell identifiers and/or DU identifiers that match the target attributes. The NF may then initiate paging toward the UE using the cell identifiers and/or DU identifiers. For example, the NF may send a paging request to the DU.

### FIELD OF THE DISCLOSURE

Aspects of the present disclosure generally relate to wireless communication and specifically relate to techniques, apparatuses, and methods associated with discovery-based paging.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples).

Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications.

Beyond 5G, new RATs, such as 6G, may be designed to implement a service-based network architecture. The proliferation of cloud networks facilitates deployment of a converged service-based architecture for wireless networks, such as 6G networks. For example, a cloud-native platform may enable a merger of core network (CN) services (sometimes referred to as functions) and radio access network (RAN) services (sometimes referred to as functions), which may simplify protocols and reduce duplication of services across the CN and the RAN. A service-based architecture may include services, an enhanced distributed unit (DU) (eDU), and a set of applications. A service may be configured with an interface such as an application programming interface (API), and an application, eDU, or wireless communication device may interact with the service using the interface.

In some examples, a user equipment (UE) may be configured to operate in a low-power state, such as a radio resource control (RRC) inactive state and/or an RRC idle state. When data becomes available for transmission to the UE, a network may transmit a paging message to prompt the UE to transition from the low-power state to a high-power state, such as an RRC connected state, and receive the data. Because the network may be unaware of which cell contains the UE in the RRC idle state, the network may transmit paging messages in various cells to ensure that the UE receives the paging message. In some examples, the network may page the UE via a central unit (CU), which can involve excessive CU processing resources and increase latency. However, because the CU stores information that is relevant to paging, bypassing the CU can prevent successful paging.

### SUMMARY

Some aspects described herein relate to an apparatus for wireless communication at a network entity. The apparatus may include one or more memories storing processor-executable code and one or more processors coupled with the one or more memories. At least one processor of the one or more processors may be configured to cause the network entity to transmit a discovery request that includes one or more attributes in accordance with a user equipment (UE) paging strategy that indicates a paging scope. At least one processor of the one or more processors may be configured to cause the network entity to receive, in accordance with the one or more attributes, a discovery response that includes discovery information indicating one or more cell identifiers, one or more identifiers of one or more distributed units (DUs), and an association between the one or more cell identifiers and the one or more identifiers of the one or more DUs. At least one processor of the one or more processors may be configured to cause the network entity to transmit one or more paging indications in accordance with the discovery information.

Some aspects described herein relate to a method of wireless communication performed at a network entity. The method may include transmitting a discovery request that includes one or more attributes in accordance with a user equipment (UE) paging strategy that indicates a paging scope. The method may include receiving, in accordance with the one or more attributes, a discovery response that includes discovery information indicating one or more cell identifiers, one or more identifiers of one or more DUs, and an association between the one or more cell identifiers and the one or more identifiers of the one or more DUs. The method may include transmitting one or more paging indications in accordance with the discovery information.

Some aspects described herein relate to an apparatus for wireless communication. The apparatus may include means for transmitting a discovery request that includes one or more attributes in accordance with a user equipment (UE) paging strategy that indicates a paging scope. The apparatus may include means for receiving, in accordance with the one or more attributes, a discovery response that includes discovery information indicating one or more cell identifiers, one or more identifiers of one or more DUs, and an association between the one or more cell identifiers and the one or more identifiers of the one or more DUs. The apparatus may include means for transmitting one or more paging indications in accordance with the discovery information.

Some aspects described herein relate to a non-transitory computer-readable medium storing a set of instructions for wireless communication. The set of instructions may include one or more instructions that, when executed at a network entity, cause the network entity to transmit a discovery request that includes one or more attributes in accordance with a user equipment (UE) paging strategy that indicates a paging scope. The set of instructions may include one or more instructions that, when executed at the network entity, cause the network entity to receive, in accordance with the one or more attributes, a discovery response that includes discovery information indicating one or more cell identifiers, one or more identifiers of one or more DUs, and an association between the one or more cell identifiers and the one or more identifiers of the one or more DUs. The set of instructions may include one or more instructions that, when executed at the network entity, cause the network entity to transmit one or more paging indications in accordance with the discovery information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated base station architecture in accordance with the present disclosure.

FIG. 3 is a diagram illustrating an example of a service-based architecture in accordance with the present disclosure.

FIG. 4 is a diagram illustrating an example protocol configuration for a service-based architecture in accordance with the present disclosure.

FIG. 5 is a diagram illustrating examples of network architectures in accordance with the present disclosure.

FIG. 6 is a diagram illustrating examples of paging support in accordance with the present disclosure.

FIG. 7 is a diagram illustrating examples of indirect paging in accordance with the present disclosure.

FIG. 8 is a diagram illustrating example associated with signaling for indirect paging in accordance with the present disclosure.

FIG. 9 is a diagram illustrating an example associated with signaling for discovery-based paging in accordance with the present disclosure.

FIG. 10 is a flowchart illustrating an example process performed, for example, at a network entity or an apparatus of a network entity that discovery-based paging in accordance with the present disclosure.

FIG. 11 is a diagram of an example apparatus for wireless communication that supports discovery-based paging in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some aspects may help to reduce central unit (CU) processing resource utilization and latency using direct paging. In direct paging, a network entity May generate a paging indication and transmit the paging indication directly to a distributed unit (DU), bypassing a CU. In some aspects, the network entity may use a discovery procedure to retrieve DU registration information from a network repository function (NRF) before transmitting the paging indication. The DU registration information may include information that is relevant to paging, such as target cell identifiers, target DU identifiers, or the like, thereby enabling the network entity to bypass the CU.

In reference point architecture, an access and mobility management function (AMF) may page a user equipment (UE) via a central unit control plane (CU-CP) and a DU. In some examples, the AMF may initiate paging on a tracking area (TA) basis, in which all cells within one or more TAs are paged. Additionally or alternatively, the AMF may initiate paging at a cell level, in which individual cells are paged.

In service-based architecture, a network function (NF) may be responsible for paging a UE. The NF may be a functional component within the service-based architecture that provides one or more defined services. For example, the NF may be a 6G core NF that manages UE access of a 6G core network. In some examples, the NF may initiate paging via a primary CU-CP of a DU that last served the UE. Additionally or alternatively, the NF may initiate paging via a last anchor CU-CP of the UE.

Thus, both reference point architecture and service-based architecture may use indirect paging, in which a paging request is transmitted toward a UE via a CU (or a CU-CP). Because the paging request propagates via the CU, indirect paging can involve excessive CU processing resources and increase latency. Accordingly, in some examples, an NF may initiate direct paging of the UE whereby the NF transmits the paging request to a DU, bypassing the CU. Direct paging may thereby reduce consumption of CU processing resources and latency.

However, the CU stores information that is relevant to paging, such as which cells are served by which DUs. As a result, direct paging (in which the CU is bypassed) can create a lack of such information. Storing DU information at the NF is impractical because networks often include large quantities of DUs that would lead to excessive consumption of NF memory resources. Furthermore, the UE can be mobile and thereby interact with multiple NFs, and storing the DU information at multiple NFs would lead to excessive consumption of NF memory resources at multiple NFs.

Various aspects relate generally to paging in a service-based architecture. Some aspects more specifically relate to a discovery procedure that enables the NF to identify information that is relevant to paging and thereby directly page the UE. In some aspects, a NRF may receive, from a DU, registration information, such as a DU identifier, area information, and/or cell information. The NRF may store the registration information, and the NF may send, to the NRF, a discovery request that specifies target attributes for the paging, such as a cell type or an area, among other examples. The NF may receive, from the NRF, a discovery response that indicates cell identifiers and/or DU identifiers that match the target attributes. The NF may then initiate paging toward the UE using the cell identifiers and/or DU identifiers. For example, the NF may send a paging request to the DU.

In some aspects, the NF may identify a UE paging strategy that defines a paging scope. The UE paging strategy may indicate a plan for paging the UE, such as when or how cells are to be paged, or whether or when to initiate paging repetitions or paging escalations, among other examples. The paging scope may indicate which cells are to be paged. For example, the paging scope may indicate a type of cell or beam that is to be paged, a geographical area including cell(s) that are to be paged, or specific cells or beams that are to be paged, among other examples. In some examples, the NF may generate the UE paging strategy using UE paging information (for example, a paging area or other paging-related information) exchanged with the UE and/or UE paging parameters (for example, a discontinuous reception (DRX) cycle or other paging-related parameters) negotiated with the UE.

In some aspects, the DU may create a cell hash of the cell identifier. The cell hash may be a representation of the cell identifier that is shorter than the cell identifier, such as an index or a handle that represents the cell identifier. For example, the DU may create a globally unique cell hash using a formula and/or a subset of bits of the cell identifier.

Particular aspects of the subject matter described in this disclosure can be implemented to realize one or more of the following potential advantages. In some examples, the described techniques can be used to perform direct paging without excessive burden on memory resources of the NF. As a result, the direct paging may reduce CU processing resources occupied due to paging and decrease latency of the paging procedure, and registration information may be stored at the NRF rather than the NF and/or multiple NFs.

The UE paging strategy defining the paging scope may help to reduce a quantity of network resources, such as bandwidth resources, processing resources, or memory resources, among other examples, that are occupied by paging operations. For example, the paging scope may help to focus paging operations on a subset of cells, thereby limiting a quantity of paging messages transmitted by the network. For example, the UE paging strategy may help to ensure that cells within the paging scope are likely to contain the UE, and that cells outside the paging scope are unlikely to contain the UE.

The cell hash may help to reduce signaling overhead by enabling transmission of a cell hash (rather than the cell identifier) over an air interface. For example, the cell hash may occupy fewer transmission resources than a cell identifier.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

Beyond 5G, new RATs, such as 6G, may be designed to implement a service-based network architecture. Such an architecture may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may introduce features to enable new applications and facilitate new use cases. The methods, operations, apparatuses, and techniques described herein may enable one or more of the foregoing technologies or new technologies and/or support one or more of the foregoing use cases or new use cases.

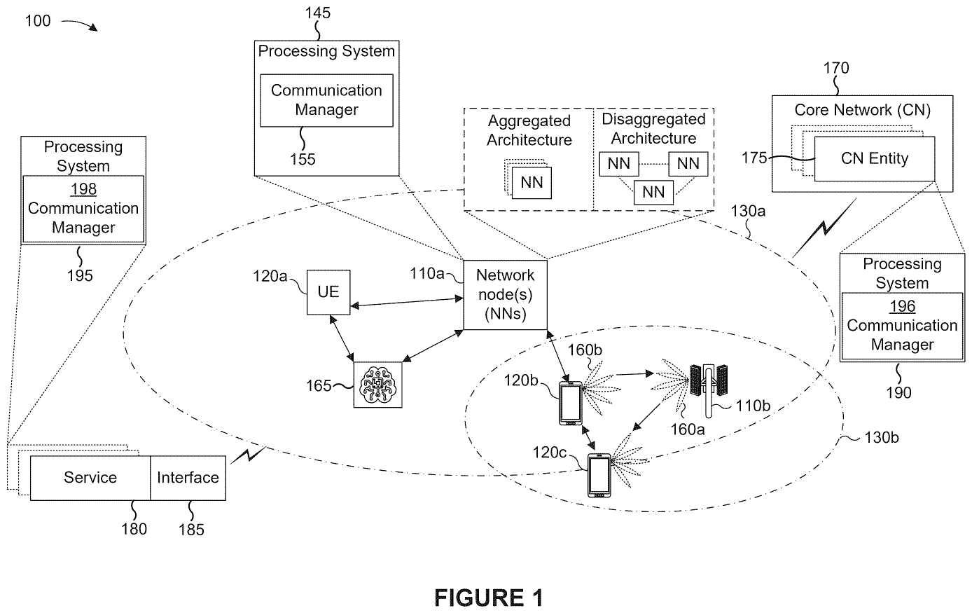

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communication with other UEs 120 and a network node 110 may communicate with a core network (CN) 170 (such as one or more CN entities 175), one or more services 180, and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. Examples of RATs include a 4G RAT, a 5G/NR RAT, and a 6G RAT. In some examples, when multiple RATs are deployed in a given geographic area, each RAT in the geographic area may operate on different frequencies to avoid interference with other RATs.

A network node 110 a UE 120, a CN entity 175, and/or a service 180 may include one or more devices, components, or systems that enable communication with other devices, components, or systems of the wireless communication network 100. For example, a UE 120, a network node 110, a CN entity 175, and/or a service 180 may include one or more chips, system-on-chips (SoCs), chipsets, packages, or devices that individually or collectively constitute or comprise a processing system, such as a processing system 145 of the network node 110 and/or a processing system 190 of a core network (CN) entity 175, and/or a processing system 195 of a service 180. A processing system (for example, the processing system 145, the processing system 190, and/or the processing system 195) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

A processing system (for example, the processing system 145, the processing system 190, and the processing system 195) may include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

A processing system (for example, the processing system 145) may include or be coupled with one or more modems (such as a cellular (for example, a 5G or 6G compliant) modem). In some examples, one or more processors of the processing system 145 include or implement one or more of the modems. The processing system 145 may also include or be coupled with multiple radios (collectively “the radio”), multiple radio frequency (RF) chains, or multiple transceivers, each of which may in turn be coupled with one or more of multiple antennas. In some examples, one or more processors of the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 145 of the network node 110). A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, and/or smart jewelry), a gaming device, an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, and/or any other suitable device or function that may communicate via a wireless medium.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical structure or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that operates with a full radio protocol stack to enable or facilitate communication between a UE 120 and the CN 170 of the wireless communication network 100.

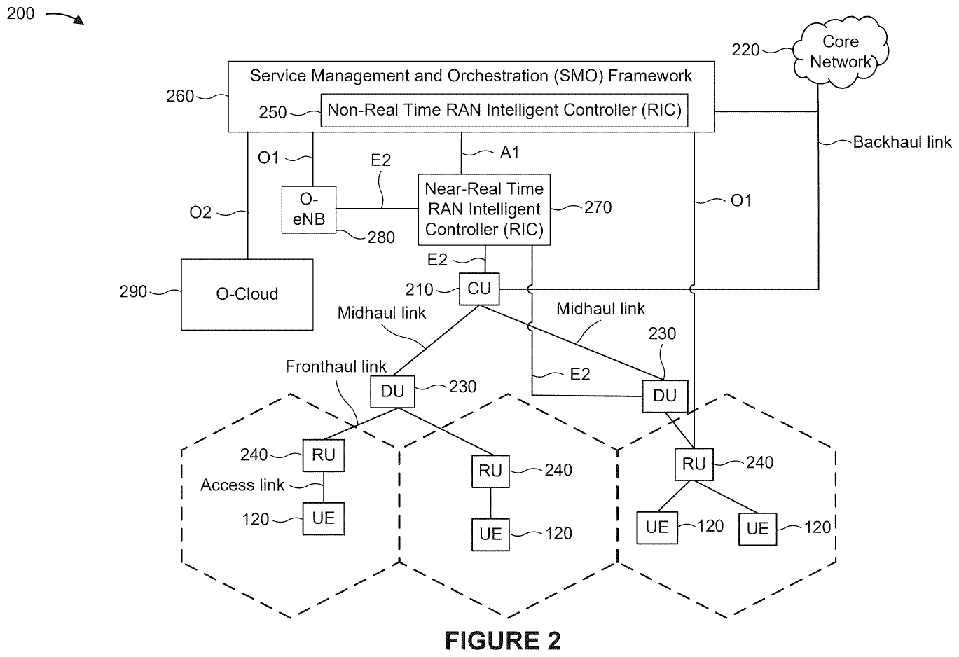

Alternatively, and as also shown, a network node 110 may be a disaggregated network node (sometimes referred to as a disaggregated base station), meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more CUs, one or more DUs, and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as an fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

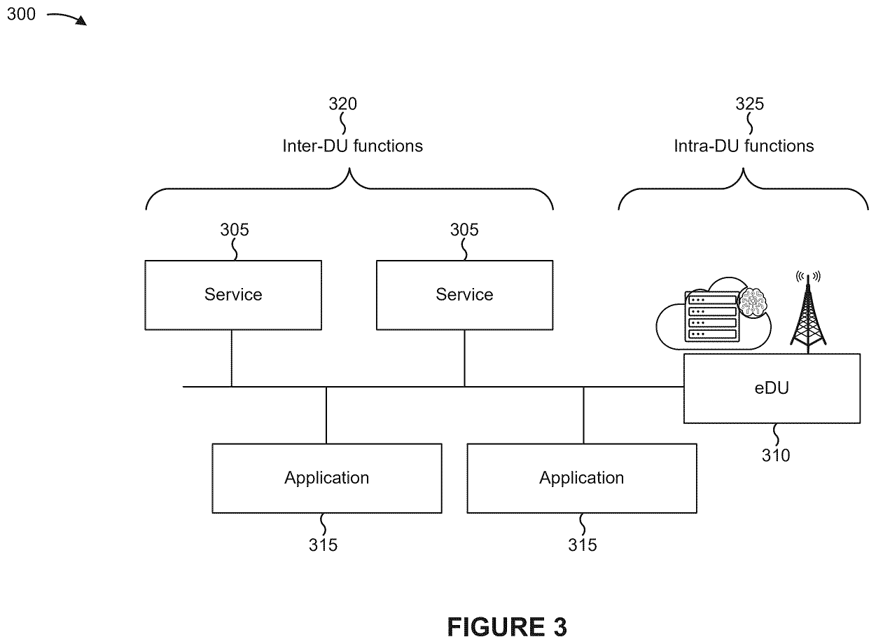

In some examples, the CN 170 may include various CN entities 175 that perform functions related to operating the wireless communication network 100. For example, the CN 170 may be a 5G core (5GC) or a 6G core. A CN entity 175 may include, for example, a mobility management entity (MME), an AMF, a gateway, a user plane function (UPF), or another CN entity. A CN entity 175, or a group of CN entities 175, may include a user plane entity that performs user plane related functions, such as packet transfer and Internet Protocol address allocation. Additionally or alternatively, a CN entity 175 or a group of CN entities 165 may include a control plane entity that manages functions such as access, mobility, security, bearer management. In some examples, one or more network nodes 110 may also perform functions. The CN 170 may be associated with a divergent architecture, as described in more detail with reference to FIG. 3.

Additionally or alternatively, a wireless communication network 100 may incorporate or otherwise be associated with one or more services 180. A service 180 may perform or be configured to perform functions related to operating the wireless communication network 100. In some aspects, a service 180 may perform or be configured to perform, for a given function, one or more operations performed by a CN entity 175 of a CN 170 and one or more operations performed by a network node 110 of a wireless communication network 100 that incorporates a CN 170. For example, functions of the CN entity 175 and functions of the network node 110 may be converged at the service 180, as described in more detail in connection with FIG. 3. As shown, one or more services 180 may be associated with an interface 185, which may include an application programming interface (API). Network nodes 110 (such as DUs), UEs 120, or other entities (such as another service 180 or a CN entity 175), may interact with the service 180 via the interface 185. A service 180 may be implemented on a physical device or as a cloud implementation (such as a virtual machine or a virtualized network function). The one or more services 180 may be associated with a service-based architecture, as described in more detail with reference to FIG. 3.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions and/or beams).

As used herein, a downlink signal may be or include a reference signal, control information or data. For example, downlink reference signals include a primary synchronization signal (PSS), a secondary SS (SSS), an SS block (SSB) (for example, that includes resources that carry a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit downlink control information (DCI) from a network node 110 to a UE 120. DCI generally contains the information the UE 120 needs to identify resource blocks (RBs) in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. A PDSCH may carry one or more transport blocks (TBs) of data.

As used herein, an uplink signal may include a reference signal, control information or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement indication or a HARQ negative acknowledgement indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 185 165 (for example, one or more a network nodes 110, and/or one or more UEs 120, and/or one or more servers, and/or one or more components of a cloud computing network, among other examples). For example, in a deployment where AI/ML functionality is performed independently at a device 165, sometimes referred to as “overlay AI/ML”, the AI/ML model (or an instance or portion of the AI/ML model) may be deployed at include a UE 120, a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable and/or RAN-based AI/ML services via one or more APIs and/or management interfaces for use cases such as beam management, radio resource monitoring (RRM) relaxation, mobility prediction, load prediction, network energy savings, and/or coverage and capacity improvements, among other examples.

In some aspects, a network entity (such as the network node 110, the CN entity 175, or the service 180) may include a communication manager 155, 196, or 198. As described in more detail elsewhere herein, the communication manager 155, 196, or 198 may transmit a discovery request that includes one or more attributes in accordance with a UE paging strategy that indicates a paging scope; receive, in accordance with the one or more attributes, a discovery response that includes discovery information indicating one or more cell identifiers, one or more identifiers of one or more DUs, and an association between the one or more cell identifiers and the one or more identifiers of the one or more DUs; and transmit one or more paging indications in accordance with the discovery information. Additionally or alternatively, the communication manager 155, 196, or 198 may perform one or more other operations described herein.

FIG. 2 is a diagram illustrating an example disaggregated base station architecture 200 in accordance with the present disclosure. One or more components of the example disaggregated base station architecture 200 may be, may include, or may be included in one or more network nodes (such one or more network nodes 110). The disaggregated base station architecture 200 may include a CU 210 that can communicate directly with a core network 220 (such as the CN 170 or one or more core network entities 175) via a backhaul link, or that can communicate indirectly with the core network 220 via one or more disaggregated control units, such as a Non-RT RIC 250 associated with a Service Management and Orchestration (SMO) Framework 260 and/or a Near-RT RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated base station architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU-CP units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers.

Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

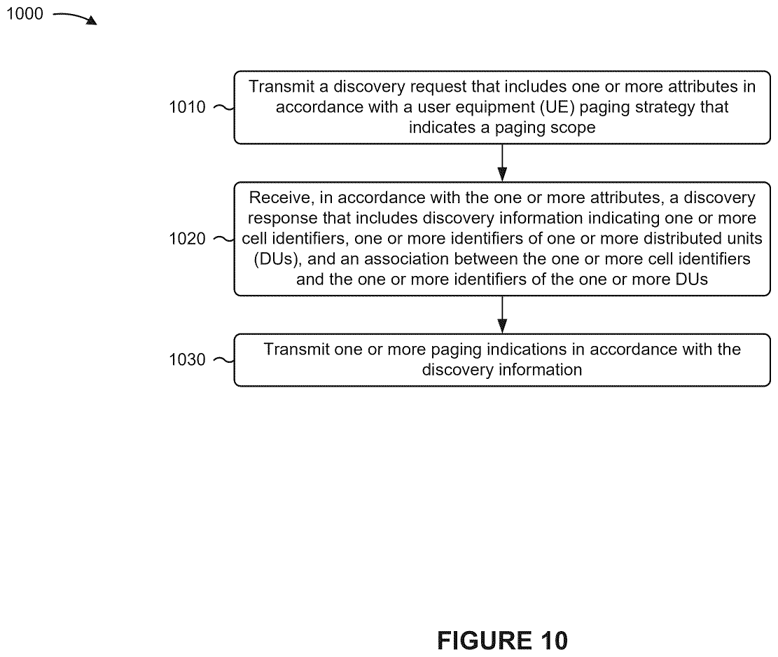

The network node 110, the processing system 145 of the network node 110, the UE 120, the processing system 190 of a CN entity 175, the processing system 195 of a service 180, the CU 210, the DU 230, the RU 240, or any other component(s) of FIG. 1 and/or FIG. 2 may implement one or more techniques or perform one or more operations associated with discovery-based paging, as described in more detail elsewhere herein. For example, the processing system 145 of the network node 110, the processing system 190 of a CN entity 175, the processing system 195 of a service 180, the CU 210, the DU 230, or the RU 240 may perform or direct operations of, for example, process 1000 of FIG. 10 or other processes as described herein (alone or in conjunction with one or more other processors). Memory of a device (for example, the network node 110, the UE 120, a CN entity 175, or a service 180) may store data and program code (or instructions) for the device. In some examples, the memory may include a non-transitory computer-readable medium storing a set of instructions for wireless communication. For example, the set of instructions, when executed by one or more processors (for example, of the processing system 145, the processing system 190, or the processing system 195) of the network node 110, the UE 120, a CN entity 175, a service 180, the CU 210, the DU 230, or the RU 240, may cause the one or more processors to perform process 1000 of FIG. 10 or other processes as described herein. In some examples, executing instructions may include running the instructions, converting the instructions, compiling the instructions, and/or interpreting the instructions, among other examples.

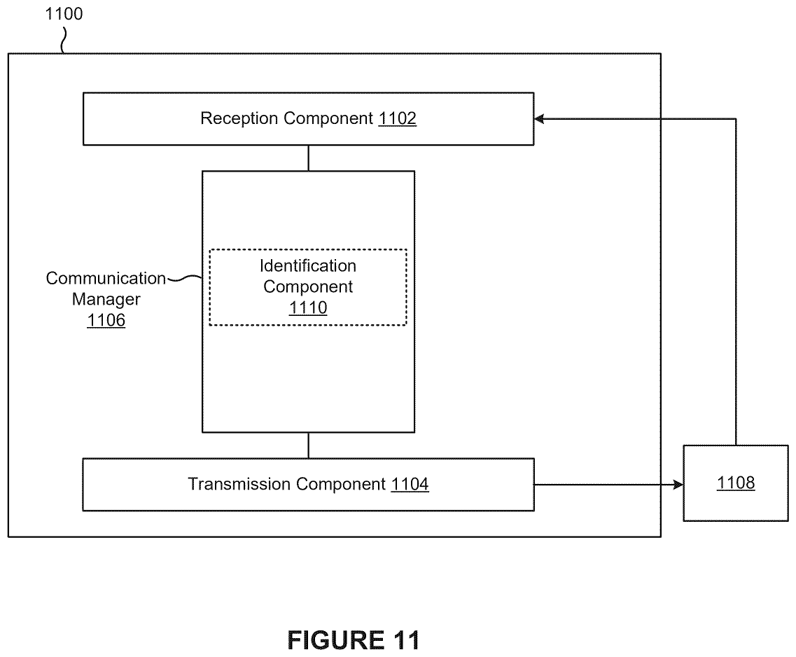

In some aspects, the network entity includes means for transmitting a discovery request that includes one or more attributes in accordance with a UE paging strategy that indicates a paging scope; means for receiving, in accordance with the one or more attributes, a discovery response that includes discovery information indicating one or more cell identifiers, one or more identifiers of one or more DUs, and an association between the one or more cell identifiers and the one or more identifiers of the one or more DUs; and/or means for transmitting one or more paging indications in accordance with the discovery information. In some aspects, the means for the network entity to perform operations described herein may include, for example, one or more of communication manager 155, 196, or 198, processing system 145, 190, or 195, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

FIG. 3 is a diagram illustrating an example of a service-based architecture 300 in accordance with the present disclosure. The proliferation of cloud networks facilitates deployment of the service-based architecture 300. For example, a cloud-native platform may enable a merger of CN services and RAN services (which may be referred to as functions), which may simplify protocols and reduce duplication of services across the CN and the RAN. The service-based architecture 300 includes services 305, an eDU 310, and a set of applications 315. A service 305 may be an example of service 180. A service 305 may be configured with an interface (such as the interface 185). A service 305 may be implemented by a service server, which may be a device or a cloud implementation (such as a virtual machine). An application 315 or an eDU 310 may interact with the service 305 using the interface. As just one example, a paging service 305 may trigger CN paging or RAN paging by interacting with the eDU 310 via the interface.

An eDU 310 may include a network entity (for example, a network node 110, a DU 230) capable of communicating with a service 305. For example, inter-DU functions 320 (which may include functions involving communication between eDUs 310, such as mobility management) may be performed by a service 305, whereas intra-DU functions 325 (which may include PHY-layer functions and some MAC layer functions) may be performed by an eDU 310. For example, real-time link management may occur at the eDU 310, which allows for more efficient activation, deactivation, and selection of features based on user experience requirements, and which decouples configuration and activation of performance-sensitive features. In some aspects, the eDU 310 may perform DU function management, such as configuration operations. For example, in a service-based architecture 300, DU function management, which may include functions performed by a CU (such as CU 210) in a divergent architecture, may be performed by the eDU 310.

In a divergent architecture, such as an architecture incorporating a CN 170 with CN entities 175, a set of network functions in the CN (such as CN 170) may handle operations relating to the CN, such as connection state management (for example, idle and inactive state management), CN paging, network capability signaling, mobility, and/or non-access stratum (NAS) security, among other examples. In such examples, a RAN node (for example, a CU (for example, CU 210, a CU-CP, a CU-UP) or a DU (for example, DU 230)) may perform operations relating to the RAN, such as access-stratum (AS) security, mobility, UE radio capability signaling, RAN paging, connection management, and/or radio bearer management, among other examples. The divergent architecture provides a hierarchy between the CN and the RAN. This hierarchy may provide for deployment to meet performance and security requirements, and may facilitate accessibility of on-site equipment. For example, a divergent architecture may facilitate an appliance-centric architecture. Furthermore, a divergent architecture may separate control-plane and user-plane functions, which facilitates separate hardware appliances for control-plane and user-plane functions in view of the different packet scaling expectations of control-plane functions versus user-plane functions.

The service-based architecture 300 may differ from a divergent architecture in that services or functions related to a given functionality (such as mobility) may be performed by a single service 305 rather than by a combination of a CN function (which may include an AMF, a UPF, a session management function (SMF), or another core network function) and a RAN node such as network node 110. For example, rather than a CN function and a RAN node communicating with one another to execute a mobility operation for a UE or an eDU 310, the eDU 310 may interface with a service 305, which may handle selection of a target eDU and configuration or other signaling related to the mobility operation. As another example, a RAN node or UE may communicate with a service 305 to initiate a mobility operation. The service 305 may perform inter-DU functions 320 for the mobility operation, such as selection of a target network node or DU, configuration of the mobility operation, and/or execution of the mobility operation. Thus, the inter-DU functions 320 for various functions such as the mobility operation are consolidated at the service 305, which improves scalability, resiliency, elasticity, agility, reuse, visibility, automation, failover, or any combinations thereof. For example, a service-based architecture 300 may facilitate individually upgrading services 305 and adaptation of services 305 across different verticals and deployment types. Furthermore, a service-based architecture 300 may provide scaling across the control plane and the user plane in a fashion that is transparent to the RAN, without necessarily implementing separate hardware for control-plane traffic and user-plane traffic.

The service-based architecture 300 may facilitate deployment of services 305 that perform a single function or type of function, thereby minimizing service interdependency and facilitating modular implementation and upgrading of services 305. Furthermore, the service-based architecture may provide fast introduction of new services relative to upgrading a divergent architecture, which may involve configuration of new hardware.

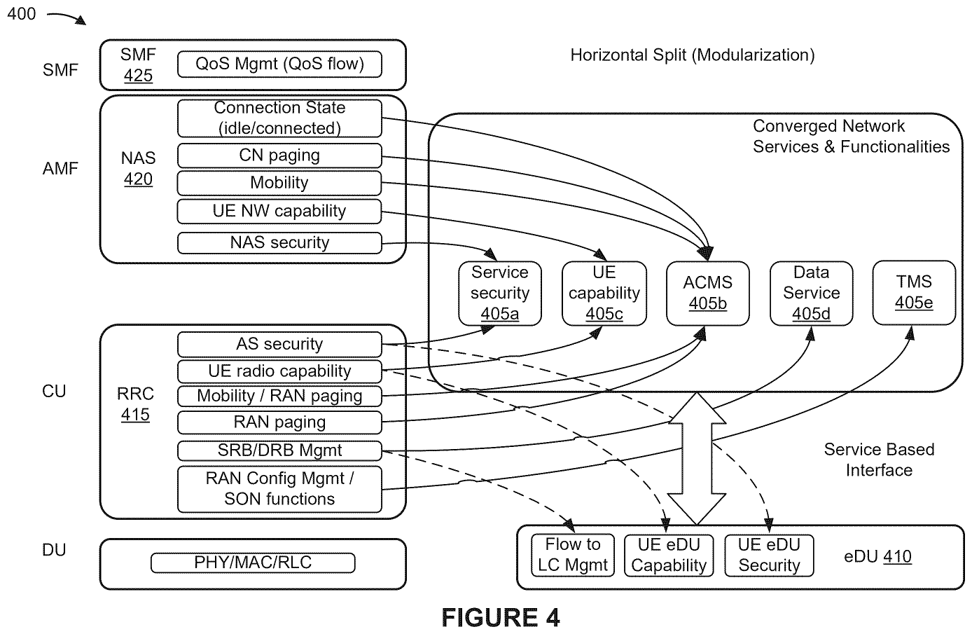

FIG. 4 is a diagram illustrating an example protocol configuration 400 for a service-based architecture in accordance with the present disclosure. The protocol configuration 400 includes a number of services 405 (for example, service 305, as shown in FIG. 3, or service 180, as shown in FIG. 1), which may be implemented by one or more service servers. FIG. 4 shows a divergent architecture. The divergent architecture includes a DU (for example, DU 230, as shown in FIG. 2) which may implement PHY, MAC, and/or RLC functions. The divergent architecture also includes a CU which may implement RRC functions 415, shown as AS security, mobility, UE radio capability signaling, RAN paging, connection management, and SRB/DRB management as an example. The divergent architecture also includes CN entities (such as CN entity 175, as shown in FIG. 1), shown as an AMF and an SMF. The AMF may implement NAS functions 420, such as connection state management, CN paging, UE network capability signaling, mobility, and/or NAS security, among other examples. In some aspects, the CN entities may include a UPF, which may implement AS functions. The SMF may implement an SMF function 425 such as quality of service (QoS) management, such as according to QoS flows.

A service-based architecture (for example, the service-based architecture 300) may include an eDU 410 (for example, eDU 310, as shown in FIG. 3, DU 230, as shown in FIG. 2, or network node 110, as shown in FIG. 1) and one or more services 405 (for example, services 180, as shown in FIG. 1, and/or services 305, as shown in FIG. 3). An arrow from a given function of the divergent architecture (for example, RRC functions 415, NAS functions 420, or SMF functions 425) to a corresponding service 405 indicates that the given function is performed by the corresponding service 405. As shown, a security service 405a may perform both NAS security and AS security, which may include authentication. An access, connectivity, and mobility service (ACMS) 405b may perform the mobility functions of a CU as well as the mobility functions of an AMF. The ACMS 405b may also perform connection management, mobility management, connection state management, CN paging, and/or RAN paging, among other examples. A UE capability service 405c may perform both UE radio capability and UE network capability functions. A data service 405d (for example, QoS service) may perform both QoS management and SRB/DRB management. In some aspects, the data service 405d may be implemented as one or more data service slices. The one or more services 405 may include a topology management service (TMS) 405e. The TMS 405e may perform RAN configuration management and/or self-organizing network (SON) functions. Furthermore, the eDU 410 may implement certain functionality, such as QoS flow to logical channel management, eDU connectivity, UE eDU capability functionality, and/or eDU security, among other examples. Thus, real-time link management may be performed at the RAN edge. The above set of services 405 are provided as an example. RAN or other services may be distributed among any number or configuration of services 405. As an example, the one or more services 405 may include an ACMS 405b, a TMS 405e, a data service 405d (or a data service slice), a subscription management service, a policy service, and a security service 405a.

Thus, services of the network (for example, the CN and the RAN) are modularized and consolidated instead of being spread across RAN nodes and CN nodes, which improves scalability, resiliency, elasticity, agility, reuse, visibility, automation, and failover handling. In this way, wireless communication networks are adapted to effectively perform cloud-native deployment.

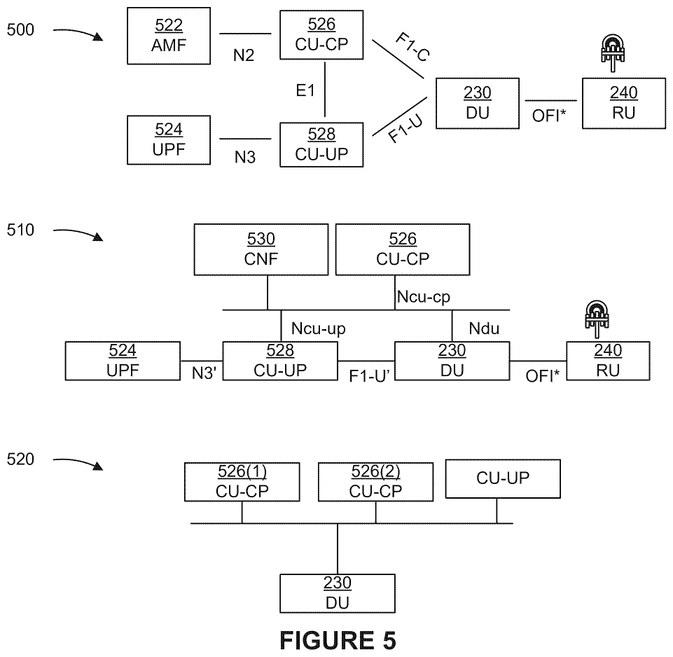

FIG. 5 is a diagram illustrating examples 500, 510, and 520 of network architectures in accordance with the present disclosure.

Example 500 shows a reference point architecture used by 5G RAN. The reference point architecture may include CN entities (such as CN entity 175, as shown in FIG. 1), shown as AMF 522 and UPF 524, and a network node 110 (for example, a gNB), as shown in FIG. 1, that includes a CU-CP unit 526 (also referred to herein as a CU-CP), one or more CU-UP units 528 (also referred to herein as a CU-UP). In some examples, the CU 210 (shown in FIG. 2) may be logically split into CU-CP(s) 526 and CU-UP(s) 528. The reference point architecture may also include one or more DUs 230 and one or more RUs 240, as shown in FIG. 2. The DU 230 and the RU 240 may be connected via an open fronthaul interface (OFI); the CU-CP 526 and the DU 230 May be connected via an F1-C interface; the CU-UP 528 and the DU 230 may be connected via an F1-U interface; the CU-UP 528 and the CU-CP 526 may be connected via an E1 interface; the CU-CP 526 and the AMF 522 may be connected via an N2 interface; and the CU-UP 528 and the UPF 524 may be connected via the N3 interface. In the reference point architecture, one DU may be connected to a single CU-CP and many CU-UPs, and one CU-UP may be connected to a single CU-CP.

Example 510 shows a service-based architecture used by 6G RAN. The reference point architecture may include a core network function (“CNF”) 530 (for example, a CN entity 175, as shown in FIG. 1), a UPF 524, one or more CU-CPs 526, one or more CU-UPs 528, one or more DUs 230, as shown in FIG. 2, and one or more RUs 240, as shown in FIG. 2. In some examples, the one or more CU-CPs 526, one or more CU-UPs 528, one or more DUs 230, and one or more RUs 240 may be included in a network node 110, as shown in FIG. 1. The DU 230 and the RU 240 may be connected via an OFI; CU-CP services may be accessed via Nou-cp APIs; CU-UP services may be accessed via Nou-up APIs; and DU services may be accessed via Ndu APIs. In the service-based architecture, one DU may support signaling with multiple CU-CPs and multiple CU-UPs, and one CU-UP may support signaling with multiple CU-CPs.

Example 520 shows a service-based architecture in which a DU 230, as shown in FIG. 2, is shared among multiple CU-CPs 526 (for example, CU-CP 526(1) and CU-CP 526(2)). The service-based architecture also includes a CU-UP 528 that can communicate with the CU-CPs 526 and the DU 230. Table 1 below illustrates priority rules for the DU across the CU-CPs: CU-CP 526(1) is a primary CU-CP of the DU 230, and CU-CP 526(2) is a secondary CU-CP of the DU 230. The priority rules may help to resolve conflicting requests by multiple CU-CPs 526, such as which CU-CP 526 is allowed to control the DU 230 to reconfigure, activate, and/or de-activate cells of the DU 230, or which CU-CP 526 is allowed to send paging message to the cells of the DU 230, among other examples. Sharing the DU 230 across multiple CU-CPs 526 may enable cost-effective deployments using purpose-specific CU-CPs 526, fine (for example, granular) load-balancing across CU-CPs 526, robust networking (for example, by providing a secondary CU-CP 526 (for example, CU-CP 526(2)) as a hot standby instead of attempting to perform a recovery upon failure of a primary CU-CP 526 (for example, CU-CP 526(1))), or fast and efficient handovers by avoiding inter-CU-CP context transfer and/or CU-UP change, among other examples.

TABLE 1

| CU-CP ID | Role/Priority |
|---|---|
| CU-CP 526(1) | Primary |
| CU-CP 526(2) | Secondary |

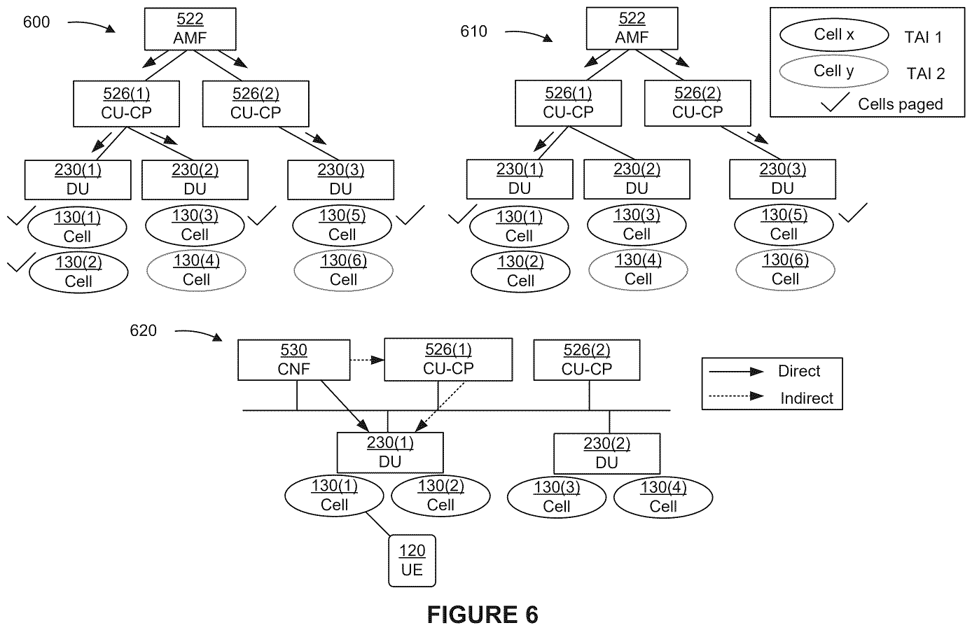

FIG. 6 is a diagram illustrating examples 600, 610, and 620 of paging support in accordance with the present disclosure.

Example 600 relates to tracking-area-level paging granularity. Example 600 includes an AMF 522 (as shown in FIG. 5), CU-CP 526(1) (as shown in FIG. 5), CU-CP 526(2) (as shown in FIG. 5), multiple DUs 230 (for example, DUs 230(1)-230(3)), as shown in FIG. 2, and multiple cells 130 (for example, cells 130(1)-130(6)), as shown in FIG. 1. As shown, the AMF 522 may page all cells 130 belonging to a tracking area with tracking area identifier (TAI) 1 (for example, cells 130(1), 130(2), 130(3), and 130(5)). In some examples, the AMF 522 may page all cells 130 belonging to a tracking area that are under a given CU-CP 526. For example, the AMF 522 may page all cells belonging to the tracking area with TAI 1 under CU-CP 526(1) (for example, cells 130(1), 130(2), and 130(3)).

Example 610 relates to cell-level paging granularity. Example 610 includes an AMF 522 (as shown in FIG. 5), CU-CP 526(1) (as shown in FIG. 5), CU-CP 526(2) (as shown in FIG. 5), multiple DUs 230 (for example, DUs 230(1)-230(3)), as shown in FIG. 2, and multiple cells 130 (for example, cells 130(1)-130(6)), as shown in FIG. 1. As shown, an AMF 522 may page specific cells. For example, the AMF may page cells 130(1) and 130(5), which are under different CU-CPs 526. For example, cell 130(1) falls under CU-CP 526(1), and cell 130(5) falls under CU-CP 526(2).

As illustrated by examples 600 and 610, the AMF 522 may page a UE 120 at different granularities (for example, at the tracking-area level (example 600) or the cell level (example 610)), and this paging is performed in two steps: from the AMF 522 to the CU-CP 526, and from the CU-CP 526 to the DU 230. This two-step paging procedure may be referred to as “indirect paging.”

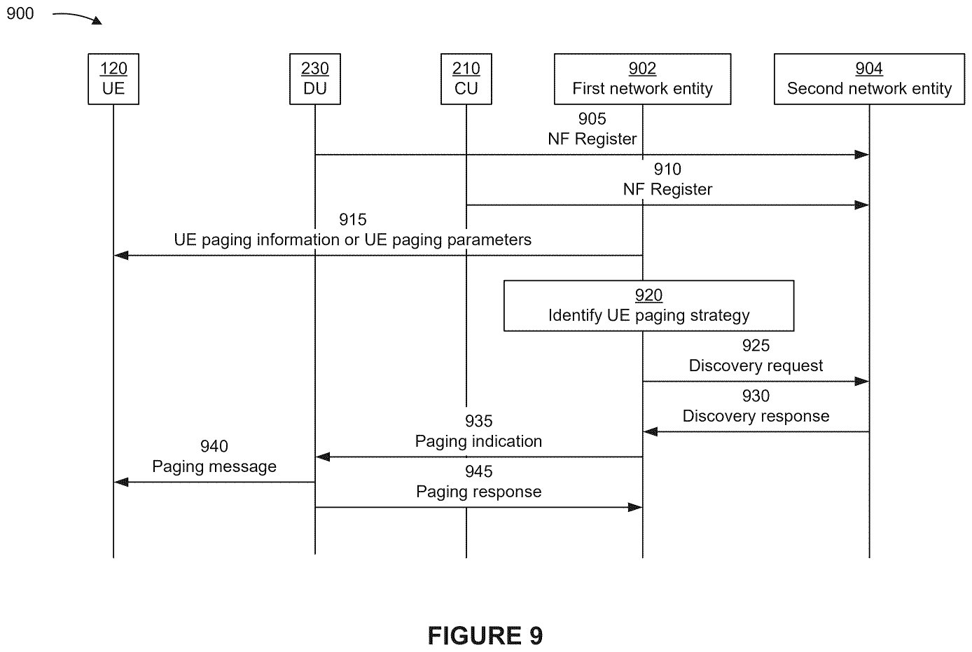

Example 620 relates to indirect paging and a one-step paging procedure referred to as “direct paging.” Example 620 includes a core network function (“CNF”) 530 (as shown in FIG. 5), CU-CP 526(1) (as shown in FIG. 5), CU-CP 526(2) (as shown in FIG. 5), multiple DUs 230 (for example, DUs 230(1) and 230(2)), as shown in FIG. 2, and multiple cells 130 (for example, cells 130(1)-130(4)), as shown in FIG. 1. In example 620, a CU-CP 526(1) may be a primary CU-CP for only DU 230(1). For example, CU-CP 526(1) may have a primary area that includes cells served by DU 230(1) (for example, cells 130(1) and 130(2)). The core network function 530 may initiate indirect paging by transmitting a paging request to a specific CU-CP 526 (for example, CU-CP 526(1)), and that CU-CP 526 may then page one or more cells (for example, cells for which the CU-CP 526(1) is a primary CU-CP, such as cells 130(1) and 130(2)). As discussed in greater detail below in connection with FIG. 9, the core network function 530 may initiate direct paging of the UE 120 on one or more specific cells of interest by discovering the DU 230 (for example, DU 230(1)) serving the specific cell(s) 130 (for example, cell 130(1)) and transmitting a paging request to the DU 230(1). Both indirect paging and direct paging may enable the core network function 530 to support paging of the UE 120 at various granularities in a service-based architecture that uses multi-CU shared DU.

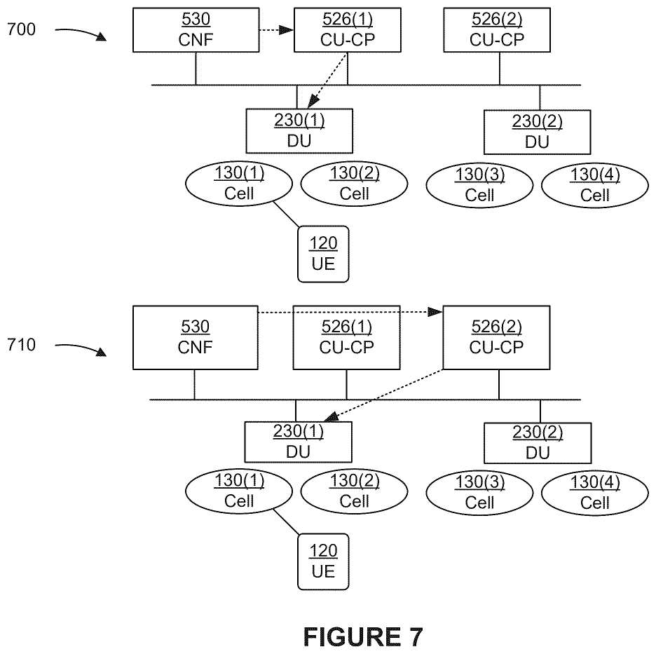

FIG. 7 is a diagram illustrating examples 700 and 710 of indirect paging in accordance with the present disclosure.

Examples 700 and 710 both include a core network function (“CNF”) 530 (as shown in FIG. 5), CU-CP 526(1) (as shown in FIG. 5), CU-CP 526(2) (as shown in FIG. 5), multiple DUs 230 (for example, DUs 230(1) and 230(2)), as shown in FIG. 2, and multiple cells 130 (for example, cells 130(1)-130(4)), as shown in FIG. 1. In examples 700 and 710, before switching to an idle mode, the UE 120 was last located in cell 130(1), served by DU 230(1), and anchored at CU-CP 256(2) (for example, the UE 120 last had an RRC connection with CU-CP 256(2)). Priority rules for the DU 230(1) may be configured as shown in Table 1 above: CU-CP 256(1) is a primary CU-CP of DU 230(1), and CU-CP 256(2) is a secondary CU-CP of DU 230(1).

Example 700 illustrates a first option for indirect paging in which the core network function pages the UE 120 via a primary CU-CP of the last serving DU 230(1) (for example, CU-CP 256(1)). Accordingly, the core network function 530 may identify the primary CU-CP 256(1) of the last serving DU 230(1) before transmitting the paging request.

Example 710 illustrates a second option for indirect paging in which the core network function pages the UE 120 via a last anchor CU-CP of the UE 120 (for example, CU-CP 256(2)). Accordingly, the core network function 530 may identify the last anchor CU-CP 256(2) of the UE 120 before transmitting the paging request.

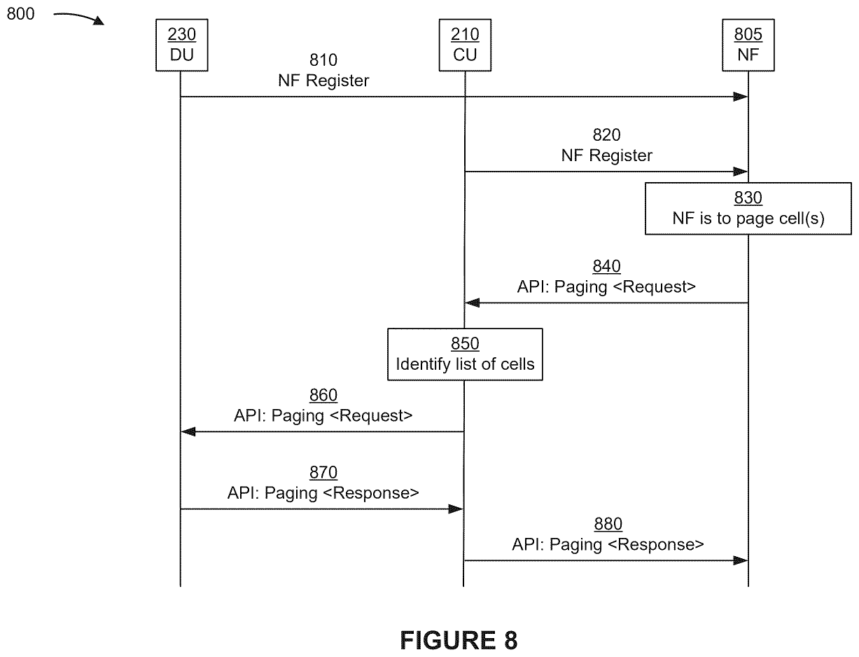

FIG. 8 is a diagram illustrating example 800 associated with signaling for indirect paging in accordance with the present disclosure. As shown in FIG. 8, a DU 230(as shown in FIG. 2), a CU 210 (as shown in FIG. 2), and an NF 805, such as a core network function (for example, core network function 530 shown in FIG. 5), may communicate with one another. In some examples, the CU 210 (shown in FIG. 2) may be logically split into CU-CP(s) 526 and CU-UP(s) 528 (shown in FIG. 5).

In a first operation 810, the DU 210 may register with the NF 805. For example, the DU 230 may indicate paging-related DU information, an identity of the DU 230 or an association of the CU 210 with the DU 230, among other examples. In a second operation 820, the CU 210 may register with the NF 805. For example, the CU 210 may indicate paging-related CU information, such as an identity of the CU 210 or an association of the CU 210 with the DU 230, among other examples. In a third operation 830, the NF 805 may identify that the NF 805 is to page one or more cells under a CU area (for example, a CU primary area). In a fourth operation 840, the NF 805 may transmit, to the CU 210 (which may be associated with the CU area), an API paging request. For example, unlike in cell-specific paging, instead of discovering the relevant DU(s), the core network (for example, the NF 805) may transmit a paging request to a specific CU of interest. In a fifth operation 850, the CU 210 may identify a list of cells to page (for example, cells 130(1) and 130(2) (shown in FIGS. 6 and 7)). For example, the list of cells to page may be those under the CU area. In a sixth operation 860, the CU 210 may transmit, to the DU 230 (which may serve cells 1 and 2), an API paging request that indicates the cells to page. In a seventh operation 870, the DU 230 may transmit, to the CU 210, an API paging response. In an eighth operation 880, the CU 210 may transmit, to the NF 805, an API paging response.

Although indirect paging may reduce NF signaling in examples where a core network is to page a wide area (for example, a CU area in a paging escalation scenario), this paging procedure may use excessive CU processing resources and increase latency due to the paging request propagating via the CU 210. By contrast, direct paging may bypass the CU 210, thereby reducing CU processing resources occupied due to paging and decreasing latency of the paging procedure. However, because the CU 210 stores information regarding which cells are served by which DUs, bypassing the CU 210 can create a lack of such information. Storing DU information at the NF 805 is impractical because networks often include large quantities of DUs that would lead to excessive consumption of NF memory resources. Furthermore, the UE 120 may be mobile and thereby interact with multiple NFs, and storing the DU information at multiple NFs would lead to excessive consumption of NF memory resources at multiple NFs.

FIG. 9 is a diagram illustrating an example 900 associated with signaling for discovery-based paging in accordance with the present disclosure. As shown in FIG. 9, a UE 120 (shown in FIG. 1), a DU 230 (shown in FIG. 2), a CU 210 (shown in FIG. 2), a first network entity 902, and a second network entity 904 may communicate with one another.

In some examples, the DU 230 may be a 6G DU, and/or the CU 210 may be a 6G CU. In some aspects, the first network entity 902 may be a core network function, a RAN node, a CU, or a DU. In some examples, the first network entity 902 may be the core network function 530 shown in FIG. 5, such as a CN entity 175 (as shown in FIG. 1). For example, the first network entity 902 may be a core network function in examples involving core-initiated paging. In some examples, the first network entity 902 may be a network node 110 (as shown in FIG. 1). In some examples (such as examples involving CU-initiated paging), the first network entity 902 may be another CU 210 (as shown in FIG. 2). For example, the first network entity 902 may be a last serving CU 210 of the UE 120. In some examples, the first network entity 902 may be another DU 230 (for example, a last serving DU of the UE 120) in examples involving DU-initiated paging. In some examples, the first network entity 902 may be any other suitable NF that can initiate paging. Additionally or alternatively, the first network entity 902 may be a service 180 (as shown in FIG. 1), among other examples. In some examples, the second network entity 904 may be a network repository function (NRF), a discovery service, a RAN service (for example, a RAN topology service), a core NF (for example, a 6G core NF), a RAN (for example, a 6G RAN), a CU, or an operations, administration, and management (OAM) server, among other examples. For example, the second network entity 904 may be a network node 110 (as shown in FIG. 1) or a CU 210 (as shown in FIG. 2), among other examples.

In a first operation 905, the DU 230 may register with the second network entity 904. For example, the DU 230 may transmit, and the second network entity 904 may receive, DU registration information. The DU registration information May indicate an identifier of the DU 230. In some examples, a plurality of DUs 230 may register with the second network entity by transmitting respective registration information to the second network entity. Thus, the second network entity may receive one or more indications of one or more identifiers of one or more DUs 230.

In some aspects, the one or more identifiers of the one or more DUs 230 may be one or more DU identifiers 230. For instance, in examples involving a split RAN architecture (where the DU 230 and the CU 210 are not co-located), the DU 230 and the CU 210 may each register with the second network entity independently of each other (for example, by transmitting respective registration information).

In some aspects, one or more identifiers of the one or more DUs 230 may be one or more RAN identifiers. For instance, in examples involving a non-split RAN architecture (where the DU 230 and the CU 210 are co-located), the DU registration information may include a RAN identifier (for example, a single identifier that identifies both the DU 230 and the CU 210) and/or area information of the RAN (for example, a served area of the RAN).

In some aspects, the one or more identifiers of the one or more DUs 230 may be one or more fully qualified domain names (FQDNs) of the one or more DUs 230 or one or more internet protocol (IP) addresses of the one or more DUs 230. For example, the one or more identifiers of the one or more DUs 230 may be 6G-DU identifiers, FQDNs identifying the DUs 230, and/or IP addresses identifying the DUs 230.

In some aspects, the one or more identifiers of the one or more DUs 230 are associated with area information and cell information. The area information may indicate an area corresponding to the DU 230, and the cell information may indicate one or more cell identifiers (for example, 6G cell identifiers) corresponding to the DU 230. A cell identifier may have a fixed length or a flexible (for example, extensible) length. In some examples, the cell identifier may include deterministically split subfields (for example, (X1-Y1 bits for subfield 1, X2-Y2 bits for subfield 2, X3-Y3 bits for subfield 3, and so forth)). In some examples, a cell identifier may be internally structureless (for example, the cell identifier may be a bitstring or an octet string, among other examples). An identifier of a DU 230 may be associated with the area information and the cell information in that the DU 230 may serve the area indicated by the area information and/or serve one or more cell(s) identified by the cell information. In some examples, the DU registration information may include the area information and the cell information.

In some aspects, the area information may indicate one or more of a tracking area, a RAN-based notification area (RNA), a registration area, a location update area, a geographical region, or a RAN-served geographical area. For example, the DU 230 may serve the tracking area, the RNA, the geographical region, and/or a RAN-served geographical area.

In some aspects, the cell information may indicate one or more of a cell local identifier including the one or more cell identifiers, a sector identifier, a beam identifier, a cell type, cell configuration information, a supported network identifier, or a globally unique cell identifier including the one or more cell identifiers. For example, the cell type may indicate a type of a cell, such as whether the cell is a non-terrestrial network (NTN) cell or a terrestrial network cell, a mobile cell or a non-mobile cell, a network energy saving (NES) cell or a non-NES cell, or an IAB or wireless access backhaul (WAB) aware cells or a non-IAB-or-WAB-aware cell, among other examples. The cell configuration information may include a frequency and/or bandwidth supported by the cell. The identified supported network may be a public land mobile network (PLMN) or a standalone non-public network (SNPN) supported by the cell, among other examples. The globally unique cell identifier may be a globally unique 6G cell identifier created by the DU 230 and/or RAN. In some examples, the DU 230 and/or RAN may create a globally unique cell identifier for each cell.

In some aspects, the one or more cell identifiers may be associated with one or more cell hashes. A cell identifier may be associated with a cell hash in that the cell hash may represent the cell identifier. For example, the cell hash may be a shortened version of the cell identifier or an index representing the cell identifier. In some examples, the DU 230 and/or RAN may create a cell hash (for example, a globally unique cell hash) for each cell using a formula and/or a subset of bits of the cell identifier. In some examples, the cell information may indicate the one or more cell hashes (for example, the DU registration information may include the one or more cell hashes).

In a second operation 910, the CU 210 may register with the second network entity 904. For example, the CU 210 may transmit, and the second network entity may receive, CU registration information. The CU registration information may indicate an identifier of the CU 210, an association between the identifier of the CU 210 and one or more identifiers of one or more DUs 230 (for example, an indication of a priority or role of the CU 210 with respect to the one or more DUs 230), or area information of the CU 210 (for example, a served area of the CU 210), among other examples. In some examples, a plurality of CUs 210 may register with the second network entity by transmitting respective registration information to the second network entity. Thus, the second network entity may receive one or more indications of one or more identifiers of one or more CUs 210, one or more associations between the one or more identifiers of the one or more CUs 210 and one or more identifiers of one or more DUs 230, or area information of the one or more CUs 210, among other examples. In some examples, an identifier of a CU 210 may be a CU identifier (for example, a 6G CU identifier), a fully-qualified domain name of the CU 210, or an internet protocol (IP) address of the CU 210, among other examples.

In some aspects, one or more indications of the one or more cell identifiers and the one or more identifiers of the one or more DUs 230 may be stored at one or more of the second network entities. For example, the DU 230, CU 210, and/or RAN may register with one or more second network entities, and the one or more second network entities may receive and store the DU registration information and/or the CU registration information.

In a third operation 915, the first network entity 902 may communicate one or more of UE paging information or UE paging parameters. In some examples, the first network entity 902 may transmit, and the UE 120 may receive, the UE paging information (for example, the first network entity 902 may assign the UE paging information to the UE 120). The UE paging information may include paging-related information, such as a paging area. In some examples, the UE 120 and the first network entity may negotiate the UE paging parameters. The UE paging parameters may include paging-related parameters, such as paging DRX parameters (for example, DRX cycle, among other examples).

In a fourth operation 920, the first network entity 902 may identify a UE paging strategy. The UE paging strategy may indicate one or more factors involved in a plan for paging the UE 120, such as when or how cells are to be paged, among other examples. In some examples, the first network entity 902 may identify the UE paging strategy using the one or more of the UE paging information or the UE paging parameters. In some examples, the UE paging strategy may indicate a paging scope. The paging scope may indicate which cells are to be paged. Additionally or alternatively, the UE paging strategy may indicate other factors, such as whether and/or when to initiate paging repetitions or paging escalations. In some examples, the first network entity 902 may generate one or more attributes using the UE paging strategy, and/or the UE paging strategy may include the one or more attributes.

In some aspects, the paging scope may indicate one or more of a cell or beam type, a geographical area, or one or more cells or beams. For example, the one or more attributes may indicate one or more of the cell or beam type (for example, a type of cell or beam that is to be paged), the geographical area (for example, a geographical area including cell(s) that are to be paged), or the one or more cells or beams (for example, specific cells or beams that are to be paged), among other examples.

In a fifth operation 925, the first network entity 902 may transmit, and the second network entity 904 may receive, a discovery request that includes the one or more attributes. The discovery request may be a request for the second network entity 904 to provide a discovery response to the discovery request in accordance with the one or more attributes. The discovery request may include the one or more attributes in accordance with the UE paging strategy. For example, the one or more attributes may be indicated by, or identified from, the UE paging strategy.

In a sixth operation 930, the second network entity 904 may transmit, and the first network entity 902 may receive, in accordance with the one or more attributes, the discovery response. The discovery response may include discovery information indicating one or more cell identifiers, one or more identifiers of one or more DUs 230, and an association between the one or more cell identifiers and the one or more identifiers of the one or more DUs 230. For example, the discovery information may be in accordance with the one or more attributes. For example, the second network entity 904 may indicate which cell identifiers and/or identifiers of the DU(s) 230 satisfy (for example, match) the one or more attributes. For example, the indicated cell identifiers and/or identifiers of the DU(s) 230 may be identified as corresponding to cells and/or DUs 230 of interest for purposes of paging. The association between the one or more cell identifiers and the one or more identifiers of the one or more DUs 230 may indicate that the one or more DUs 230 serve one or more cells corresponding to the one or more cell identifiers. Additionally or alternatively, the discovery information may indicate one or more identifiers of one or more CUs 210 and/or an association between the one or more identifiers of the one or more CUs 210 and the one or more identifiers of the one or more DUs 230, among other examples.

In a seventh operation 935, the first network entity 902 may transmit, and the DU 230 may receive, a paging indication in accordance with the discovery information.

In some examples, the first network entity 902 may transmit, and one or more DUs 230 may receive, one or more paging indications. Thus, the first network entity 902 may perform direct paging. The one or more paging indications may include the one or more cell identifiers indicated in the discovery response (for example, the one or more paging indications may include a list of cell(s) that are to be paged). The one or more DUs 230 may be associated with (for example, serve) the cell(s) identified by the one or more cell identifiers.

In some aspects, the one or more paging indications may be one or more paging requests that indicate one or more cells or beams. The one or more cells or beams may correspond to the one or more cell or beam identifiers indicated in the discovery response. In some examples, the one or more paging requests may be formatted in accordance with a paging API (“API: Paging <Request>”).

In some aspects, the first network entity 902 may receive one or more subscription indications associated with the one or more DUs 230. A subscription indication may be associated with a DU 230 in that the subscription indication causes the DU 230 to be subscribed paging indications from the first network entity 902. In some examples, the one or more paging indications may be one or more responses to the one or more subscription indications. For example, the first network entity 902 may notify the DU 230 (for example, using a paging indication) when the UE 120 is to be paged.

In an eighth operation 940, the DU 230 may transmit, and the UE 120 may receive, a paging message in accordance with the paging indication. For example, the UE 120 may be located in one of the one or more cells.

In a ninth operation 945, the first network entity 902 may receive one or more paging responses to the one or more paging requests. In some examples, the one or more paging requests may be formatted in accordance with a paging API (“API: Paging <Response>”).

In some aspects, the one or more paging responses may include a positive acknowledgment or a negative acknowledgment. The positive acknowledgment may indicate that the DU 230 transmitted the paging message and/or that the UE 120 received the paging message. The negative acknowledgment may indicate that the DU 230 did not transmit the paging message and/or that the UE 120 did not receive the paging message. In some examples, a paging response may include additional information regarding the paging message.

Additionally or alternatively, the first network entity 902 may perform indirect paging as discussed above in connection with FIGS. 6-8. For example, after receiving the discovery response, the first network entity 902 may transmit a paging request (“API: Paging <Request>”) to the CU 210, and the CU 210 may transmit the paging request to the DU 230. Additionally or alternatively, the DU 210 may be subscribed to receive paging indications from the first network entity, and the first network entity may notify the DU 210 (for example, via the CU 230) when the UE 120 is to be paged. The CU 230 may serve an area that is to be paged. In some examples, the CU 230 may be a primary CU of the last serving DU of the UE 120, which the first network entity 902 may identify using a UE location report that indicates a primary CU identifier or using the discovery information in the discovery response. In some examples, the CU 210 may be a last serving CU of the UE 120, which the first network entity 902 may identify using a callback identifier, a uniform resource locator, or an IP address received during a last association of the first network entity 902 with the CU 210. The DU 230 may transmit, and the UE 120 may receive, a paging message in accordance with the paging request or paging indication. In some examples, the DU 230 may transmit a paging response (“API: Paging <Response>”) to the CU 210, and the CU 210 may transmit the paging response to the first network entity 902.

Receiving the discovery response that includes the discovery information may enable the first network entity 902 to perform direct paging without excessive burden on memory resources of the first network entity 902. As a result, the direct paging may reduce CU processing resources occupied due to paging and decrease latency of the paging procedure, and registration information may be stored at the second network entity 904 rather than the first network entity 902 (for example, rather than at a plurality of first network entities 902).

The UE paging strategy indicating the paging scope may help to reduce a quantity of network resources, such as bandwidth resources, processing resources, or memory resources, among other examples, that are occupied by paging operations. For example, the paging scope may help to focus paging operations on a subset of cells, thereby limiting a quantity of paging messages transmitted by the network. For example, the UE paging strategy may help to ensure that cells within the paging scope are likely to contain the UE 120, and that cells outside the paging scope are unlikely to contain the UE 120.

The one or more cell identifiers being associated with the one or more cell hashes may help to reduce signaling overhead by transmitting a cell hash as a handle or index of a cell identifier over an air interface.

FIG. 10 is a flowchart illustrating an example process 1000 performed, for example, at a network entity or an apparatus of a network entity that discovery-based paging in accordance with the present disclosure. Example process 1000 is an example where the apparatus or the network entity (for example, network node 110 or CN entity 175) performs operations associated with discovery-based paging.

As shown in FIG. 10, in some aspects, process 1000 may include transmitting a discovery request that includes one or more attributes in accordance with a UE paging strategy that indicates a paging scope (block 1010). For example, the network entity (such as by using communication manager 1106 or transmission component 1104, depicted in FIG. 11) may transmit a discovery request that includes one or more attributes in accordance with a UE paging strategy that indicates a paging scope, as described above in connection with reference number 925 (FIG. 9).

As further shown in FIG. 10, in some aspects, process 1000 may include receiving, in accordance with the one or more attributes, a discovery response that includes discovery information indicating one or more cell identifiers, one or more identifiers of one or more DUs, and an association between the one or more cell identifiers and the one or more identifiers of the one or more DUs (block 1020). For example, the network entity (such as by using communication manager 1106 or reception component 1102, depicted in FIG. 11) may receive, in accordance with the one or more attributes, a discovery response that includes discovery information indicating one or more cell identifiers, one or more identifiers of one or more DUs, and an association between the one or more cell identifiers and the one or more identifiers of the one or more DUs, as described above in connection with reference number 930 (FIG. 9).

As further shown in FIG. 10, in some aspects, process 1000 may include transmitting one or more paging indications in accordance with the discovery information (block 1030). For example, the network entity (such as by using communication manager 1106 or transmission component 1104, depicted in FIG. 11) may transmit one or more paging indications in accordance with the discovery information, as described above in connection with reference number 935 (FIG. 9).

Process 1000 may include additional aspects, such as any single aspect or any combination of aspects described below or in connection with one or more other processes described elsewhere herein.

In a first additional aspect, one or more indications of the one or more cell identifiers and the one or more identifiers of the one or more DUs are stored at one or more of a NRF, a discovery service, a RAN service, a core network function, a RAN, a CU, or an OAM server.

In a second additional aspect, alone or in combination with the first aspect, the one or more identifiers of the one or more DUs are one or more DU identifiers.

In a third additional aspect, alone or in combination with one or more of the first and second aspects, the one or more identifiers of the one or more DUs are one or more RAN identifiers.

In a fourth additional aspect, alone or in combination with one or more of the first through third aspects, the one or more identifiers of the one or more DUs are one or more FQDNs of the one or more DUs or one or more IP addresses of the one or more DUs.

In a fifth additional aspect, alone or in combination with one or more of the first through fourth aspects, the one or more identifiers of the one or more DUs are associated with area information and cell information.

In a sixth additional aspect, alone or in combination with one or more of the first through fifth aspects, the area information indicates one or more of a tracking area, an RNA, a registration area, a location update area, a geographical region, or a RAN-served geographical area.

In a seventh additional aspect, alone or in combination with one or more of the first through sixth aspects, the cell information indicates one or more of a cell local identifier comprising the one or more cell identifiers, a sector identifier, a beam identifier, a cell type, cell configuration information, a supported network identifier, or a globally unique cell identifier comprising the one or more cell identifiers.

In an eighth additional aspect, alone or in combination with one or more of the first through seventh aspects, the one or more cell identifiers are associated with one or more cell hashes.

In a ninth additional aspect, alone or in combination with one or more of the first through eighth aspects, process 1000 includes communicating one or more of UE paging information or UE paging parameters.

In a tenth additional aspect, alone or in combination with one or more of the first through ninth aspects, process 1000 includes identifying the UE paging strategy using the one or more of the UE paging information or the UE paging parameters.

In an eleventh additional aspect, alone or in combination with one or more of the first through tenth aspects, the paging scope indicates one or more of a cell or beam type, a geographical area, or one or more cells or beams.

In a twelfth additional aspect, alone or in combination with one or more of the first through eleventh aspects, the one or more paging indications are one or more paging requests that indicate one or more cells or beams.

In a thirteenth additional aspect, alone or in combination with one or more of the first through twelfth aspects, process 1000 includes receiving one or more paging responses to the one or more paging requests.

In a fourteenth additional aspect, alone or in combination with one or more of the first through thirteenth aspects, the one or more paging responses includes a positive acknowledgment or a negative acknowledgment.

In a fifteenth additional aspect, alone or in combination with one or more of the first through fourteenth aspects, process 1000 includes receiving one or more subscription indications associated with the one or more DUs, and the one or more paging indications are one or more responses to the one or more subscription indications.

In a sixteenth additional aspect, alone or in combination with one or more of the first through fifteenth aspects, the network entity is a core network function, a RAN node, a CU, or a DU.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a diagram of an example apparatus 1100 for wireless communication that supports discovery-based paging in accordance with the present disclosure. The apparatus 1100 may be a network entity, or a network entity may include the apparatus 1100. In some aspects, the apparatus 1100 includes a reception component 1102, a transmission component 1104, and a communication manager 1106, which may be in communication with one another (for example, via one or more buses). As shown, the apparatus 1100 may communicate with another apparatus 1108 (such as a UE 120, a network node 110, or another wireless communication device) using the reception component 1102 and the transmission component 1104. The communication manager 1106 may be included in, or implemented via, a processing system (for example, the processing system 145 or 190). In some aspects, the communication manager 1106 is the communication manager 155, 196, or 198.

In some aspects, the apparatus 1100 may be configured to and/or operable to perform one or more operations described herein in connection with FIG. 9. Additionally or alternatively, the apparatus 1100 may be configured to and/or operable to perform one or more processes described herein, such as process 1000 of FIG. 10.

The reception component 1102 may receive communications, such as reference signals, control information, and/or data communications, from the apparatus 1108. The reception component 1102 may provide received communications to one or more other components of the apparatus 1100, such as the communication manager 1106. In some aspects, the reception component 1102 may perform signal processing on the received communications, and may provide the processed signals to the one or more other components in a similar manner as described above in connection with FIG. 1. In some aspects, the reception component 1102 may include one or more components of the network entity described above in connection with FIG. 1, such as a radio, one or more RF chains, one or more transceivers, or one or more modems, each of which may in turn be coupled with one or more antennas of the network entity.

The transmission component 1104 may transmit communications, such as reference signals, control information, and/or data communications, to the apparatus 1108. In some aspects, the communication manager 1106 may generate communications and may transmit the generated communications to the transmission component 1104 for transmission to the apparatus 1108. In some aspects, the transmission component 1104 may perform signal processing on the generated communications, and may transmit the processed signals to the apparatus 1108 in a similar manner as described above in connection with FIG. 1. In some aspects, the transmission component 1104 may include one or more components of the network entity described above in connection with FIG. 1, such as a radio, one or more RF chains, one or more transceivers, or one or more modems, each of which may in turn be coupled with one or more antennas of the network entity. In some aspects, the transmission component 1104 may be co-located with the reception component 1102.

The communication manager 1106 may transmit or may cause the transmission component 1104 to transmit a discovery request that includes one or more attributes in accordance with a UE paging strategy that indicates a paging scope. The communication manager 1106 may receive or may cause the reception component 1102 to receive, in accordance with the one or more attributes, a discovery response that includes discovery information indicating one or more cell identifiers, one or more identifiers of one or more DUs, and an association between the one or more cell identifiers and the one or more identifiers of the one or more DUs. The communication manager 1106 may transmit or may cause the transmission component 1104 to transmit one or more paging indications in accordance with the discovery information. In some aspects, the communication manager 1106 may perform one or more operations described elsewhere herein as being performed by one or more components of the communication manager 1106.

In some aspects, the communication manager 1106 includes a set of components, such as an identification component 1110. Alternatively, the set of components may be separate and distinct from the communication manager 1106. As used herein, the term “component” is intended to be broadly construed as hardware or a combination of hardware and at least one of software or firmware. In some aspects, one or more components of the set of components may include or may be implemented within a processing system (for example, the processing system 145, 190, or 195). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 1104 may transmit a discovery request that includes one or more attributes in accordance with a UE paging strategy that indicates a paging scope. The reception component 1102 may receive, in accordance with the one or more attributes, a discovery response that includes discovery information indicating one or more cell identifiers, one or more identifiers of one or more DUs, and an association between the one or more cell identifiers and the one or more identifiers of the one or more DUs. The transmission component 1104 may transmit one or more paging indications in accordance with the discovery information. In some aspects, the reception component 1102 or the transmission component 1104 may communicate one or more of UE paging information or UE paging parameters. In some aspects, the identification component 1110 may identify the UE paging strategy using the one or more of the UE paging information or the UE paging parameters. In some aspects, the reception component 1102 may receive one or more paging responses to the one or more paging requests. In some aspects, the reception component 1102 may receive one or more subscription indications associated with the one or more DUs.

The quantity and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed at a network entity, comprising: transmitting a discovery request that includes one or more attributes in accordance with a UE paging strategy that indicates a paging scope; receiving, in accordance with the one or more attributes, a discovery response that includes discovery information indicating one or more cell identifiers, one or more identifiers of one or more distributed units (DUs), and an association between the one or more cell identifiers and the one or more identifiers of the one or more DUs; and transmitting one or more paging indications in accordance with the discovery information.
Aspect 2: The method of Aspect 1, wherein one or more indications of the one or more cell identifiers and the one or more identifiers of the one or more DUs are stored at one or more of a network repository function (NRF), a discovery service, a radio access network (RAN) service, a core network function, a RAN, a CU, or an operations, administration, and management (OAM) server.
Aspect 3: The method of any of Aspects 1-2, wherein the one or more identifiers of the one or more DUs are one or more DU identifiers.
Aspect 4: The method of any of Aspects 1-3, wherein the one or more identifiers of the one or more DUs are one or more radio access network (RAN) identifiers.
Aspect 5: The method of any of Aspects 1-4, wherein the one or more identifiers of the one or more DUs are one or more fully qualified domain names (FQDNs) of the one or more DUs or one or more internet protocol (IP) addresses of the one or more DUs.
Aspect 6: The method of any of Aspects 1-5, wherein the one or more identifiers of the one or more DUs are associated with area information and cell information.
Aspect 7: The method of Aspect 6, wherein the area information indicates one or more of a tracking area, a radio access network (RAN) based notification area, a registration area, a location update area, a geographical region, or a RAN-served geographical area.
Aspect 8: The method of Aspect 6, wherein the cell information indicates one or more of a cell local identifier comprising the one or more cell identifiers, a sector identifier, a beam identifier, a cell type, cell configuration information, a supported network identifier, or a globally unique cell identifier comprising the one or more cell identifiers.
Aspect 9: The method of any of Aspects 1-8, wherein the one or more cell identifiers are associated with one or more cell hashes.
Aspect 10: The method of any of Aspects 1-9, further comprising: communicating one or more of UE paging information or UE paging parameters.
Aspect 11: The method of Aspect 10, further comprising: identifying the UE paging strategy using the one or more of the UE paging information or the UE paging parameters.
Aspect 12: The method of Aspect 1, wherein the paging scope indicates one or more of a cell or beam type, a geographical area, or one or more cells or beams.
Aspect 13: The method of any of Aspects 1-12, wherein the one or more paging indications are one or more paging requests that indicate one or more cells or beams.
Aspect 14: The method of Aspect 13, further comprising: receiving one or more paging responses to the one or more paging requests.
Aspect 15: The method of Aspect 14, wherein the one or more paging responses includes a positive acknowledgment or a negative acknowledgment.
Aspect 16: The method of any of Aspects 1-15, further comprising: receiving one or more subscription indications associated with the one or more DUs, wherein the one or more paging indications are one or more responses to the one or more subscription indications.
Aspect 17: The method of any of Aspects 1-16, wherein the network entity is a core network function, a radio access network (RAN) node, a central unit (CU), or a DU.
Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.
Aspect 19: An apparatus for wireless communication at a device, the apparatus comprising one or more memories and one or more processors coupled to the one or more memories, the one or more processors configured to cause the device to perform the method of one or more of Aspects 1-17.
Aspect 20: An apparatus for wireless communication, the apparatus comprising at least one means for performing the method of one or more of Aspects 1-17.
Aspect 21: A non-transitory computer-readable medium storing code for wireless communication, the code comprising instructions executable by one or more processors to perform the method of one or more of Aspects 1-17.
Aspect 22: A non-transitory computer-readable medium storing a set of instructions for wireless communication, the set of instructions comprising one or more instructions that, when executed by one or more processors of a device, cause the device to perform the method of one or more of Aspects 1-17.
Aspect 23: A device for wireless communication, the device comprising a processing system that includes one or more processors and one or more memories coupled with the one or more processors, the processing system configured to cause the device to perform the method of one or more of Aspects 1-17.
Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a network entity, comprising:
one or more memories storing processor-executable code; and
one or more processors coupled with the one or more memories, at least one processor of the one or more processors configured to cause the network entity to:
transmit a discovery request that includes one or more attributes in accordance with a user equipment (UE) paging strategy that indicates a paging scope;
receive, in accordance with the one or more attributes, a discovery response that includes discovery information indicating one or more cell identifiers, one or more identifiers of one or more distributed units (DUs), and an association between the one or more cell identifiers and the one or more identifiers of the one or more DUs; and
transmit one or more paging indications in accordance with the discovery information.

2. The apparatus of claim 1, wherein one or more indications of the one or more cell identifiers and the one or more identifiers of the one or more DUs are stored at one or more of a network repository function (NRF), a discovery service, a radio access network (RAN) service, a core network function, a RAN, a CU, or an operations, administration, and management (OAM) server.

3. The apparatus of claim 1, wherein the one or more identifiers of the one or more DUs are one or more DU identifiers, one or more radio access network (RAN) identifiers, one or more fully qualified domain names (FQDNs) of the one or more DUs, or one or more internet protocol (IP) addresses of the one or more DUs.

4. The apparatus of claim 1, wherein the one or more identifiers of the one or more DUs are associated with area information and cell information.

5. The apparatus of claim 4, wherein the area information indicates one or more of a tracking area, a radio access network (RAN) based notification area, a registration area, a location update area, a geographical region, or a RAN-served geographical area.

6. The apparatus of claim 4, wherein the cell information indicates one or more of a cell local identifier comprising the one or more cell identifiers, a sector identifier, a beam identifier, a cell type, cell configuration information, a supported network identifier, or a globally unique cell identifier comprising the one or more cell identifiers.

7. The apparatus of claim 1, wherein the one or more cell identifiers are associated with one or more cell hashes.

8. The apparatus of claim 1, wherein at least one processor of the one or more processors is configured to cause the network entity to:
communicate one or more of UE paging information or UE paging parameters.

9. The apparatus of claim 8, wherein at least one processor of the one or more processors is configured to cause the network entity to:
identify the UE paging strategy using the one or more of the UE paging information or the UE paging parameters.

10. The apparatus of claim 1, wherein the paging scope indicates one or more of a cell or beam type, a geographical area, or one or more cells or beams.

11. The apparatus of claim 1, wherein the one or more paging indications are one or more paging requests that indicate one or more cells or beams.

12. The apparatus of claim 11, wherein at least one processor of the one or more processors is configured to cause the network entity to:
receive one or more paging responses to the one or more paging requests.

13. The apparatus of claim 12, wherein the one or more paging responses includes a positive acknowledgment or a negative acknowledgment.

14. The apparatus of claim 1, wherein at least one processor of the one or more processors is configured to cause the network entity to:
receive one or more subscription indications associated with the one or more DUs, wherein the one or more paging indications are one or more responses to the one or more subscription indications.

15. The apparatus of claim 1, wherein the network entity is a core network function, a radio access network (RAN) node, a central unit (CU), or a DU.

16. A method of wireless communication performed at a network entity, comprising:
transmitting a discovery request that includes one or more attributes in accordance with a user equipment (UE) paging strategy that indicates a paging scope;
receiving, in accordance with the one or more attributes, a discovery response that includes discovery information indicating one or more cell identifiers, one or more identifiers of one or more distributed units (DUs), and an association between the one or more cell identifiers and the one or more identifiers of the one or more DUs; and
transmitting one or more paging indications in accordance with the discovery information.

17. The method of claim 16, wherein one or more indications of the one or more cell identifiers and the one or more identifiers of the one or more DUs are stored at one or more of a network repository function (NRF), a discovery service, a radio access network (RAN) service, a core network function, a RAN, a CU, or an operations, administration, and management (OAM) server.

18. The method of claim 16, wherein the one or more identifiers of the one or more DUs are one or more DU identifiers, one or more radio access network (RAN) identifiers, one or more fully qualified domain names (FQDNs) of the one or more DUs, or one or more internet protocol (IP) addresses of the one or more DUs.

19. The method of claim 16, wherein the one or more identifiers of the one or more DUs are associated with area information and cell information.

20. The method of claim 19, wherein the area information indicates one or more of a tracking area, a radio access network (RAN) based notification area, a registration area, a location update area, a geographical region, or a RAN-served geographical area.

21. The method of claim 19, wherein the cell information indicates one or more of a cell local identifier comprising the one or more cell identifiers, a sector identifier, a beam identifier, a cell type, cell configuration information, a supported network identifier, or a globally unique cell identifier comprising the one or more cell identifiers.

22. The method of claim 16, wherein the one or more cell identifiers are associated with one or more cell hashes.

23. The method of claim 16, further comprising:
communicating one or more of UE paging information or UE paging parameters.

24. The method of claim 23, further comprising:
identifying the UE paging strategy using the one or more of the UE paging information or the UE paging parameters.

25. The method of claim 16, wherein the paging scope indicates one or more of a cell or beam type, a geographical area, or one or more cells or beams.

26. The method of claim 16, wherein the one or more paging indications are one or more paging requests that indicate one or more cells or beams.

27. The method of claim 26, further comprising:
receiving one or more paging responses to the one or more paging requests.

28. The method of claim 27, wherein the one or more paging responses includes a positive acknowledgment or a negative acknowledgment.

29. An apparatus for wireless communication, comprising:
means for transmitting a discovery request that includes one or more attributes in accordance with a user equipment (UE) paging strategy that indicates a paging scope;
means for receiving, in accordance with the one or more attributes, a discovery response that includes discovery information indicating one or more cell identifiers, one or more identifiers of one or more distributed units (DUs), and an association between the one or more cell identifiers and the one or more identifiers of the one or more DUs; and
means for transmitting one or more paging indications in accordance with the discovery information.

30. A non-transitory computer-readable medium storing a set of instructions for wireless communication, the set of instructions comprising:
one or more instructions that, when executed at a network entity, cause the network entity to:
transmit a discovery request that includes one or more attributes in accordance with a user equipment (UE) paging strategy that indicates a paging scope;
receive, in accordance with the one or more attributes, a discovery response that includes discovery information indicating one or more cell identifiers, one or more identifiers of one or more distributed units (DUs), and an association between the one or more cell identifiers and the one or more identifiers of the one or more DUs; and
transmit one or more paging indications in accordance with the discovery information.
